(19) United States
(12) Patent Application Publication
(10) Pub. No.: US 2011/0216546 A1
(43) Pub. Date: Sep. 8, 2011

(54) LAMPHOLDER WITH OCCUPANCY SENSOR

(75) Inventors: Alfred J. Lombardi, Syosset, NY (US); Kangpin Tee, Brooklyn, NY (US); Edward Krajci, Garden City So., NY (US)

(73) Assignee: Leviton Manufacturing Co., Inc., Melville, NY (US)

(21) Appl. No.: 13/016,186

(22) Filed: Jan. 28, 2011

Related U.S. Application Data
(63) Continuation-in-part of application No. 29/356,858, filed on Mar. 3, 2010, now Pat. No. D634048.

(51) Int. Cl. F21V 15/01; B23P 11/00

(52) U.S. Cl. 362/365; 29/525.01

(57) ABSTRACT

An electrical device is described having surface mounting structure for mounting the electrical device in one of at least three different mounting patterns. In one embodiment, the electrical device is a lampholder having an occupancy sensor. In this embodiment, the occupancy sensor defines a coverage area and an un-coverage area when the lampholder is mounted to a surface, such as a ceiling, via the surface mounting structure; and, the surface mounting structure includes four sets of keyholes enabling the lampholder to be mounted to fasteners on the surface in one of a plurality of different mounting patterns for positioning the un-coverage area in a desired location, such as, for example, opposite the closest entry point to a room. The coverage area corresponds to a detection field of the occupancy sensor. Motion in the detection field is detected by the occupancy sensor.

### CROSS REFERENCE TO RELATED APPLICATIONS

This application relates to U.S. Design patent application No. 29/356,858 filed Mar. 3, 2010, the entire contents of which are incorporated by reference herein.

### BACKGROUND

1. Field of the Related Art

The present disclosure relates to surface mounting structures, and more particularly, to a lampholder with occupancy sensor having surface mounting structure for mounting the lampholder to a ceiling or other surface in a plurality of mounting patterns.

2. Background of the Related Art

One typical mounting structure for mounting an electrical device, such as a lampholder, to a surface, such as a ceiling or outlet box, is two sets of keyholes as shown in FIG. 1 for lampholder 100. The two sets of keyholes 112, 114 are located on different centers to accept mounting screws for mounting the disc-shaped body member 101 to a surface, such as a ceiling. For example, keyholes 114 are for mounting the lampholder 100 to fasteners, such as screws, spaced three and one-half inches apart on the ceiling, and keyholes 112 are for mounting the lampholder 100 to fasteners, such as screws, spaced four inches apart on the ceiling. The screws are partially threaded to the surface, such as the ceiling, such that the heads are easily inserted within one of the set of keyholes 112, 114.

To attach the lampholder 100 to the surface, the large end apertures 116 of keyholes 112 are placed over the screw heads of two screws spaced four inches apart, and the body member 101 is then rotated clockwise to position the threaded bodies of the screws into elongated slots 118. The screws are then further threaded into the ceiling or tightened to complete the assembly of the lampholder 100 to the ceiling. For screws which are spaced three and one-half inches apart, the procedure for mounting the disc is similar, except the orientation of the keyholes 114 are reversed and, therefore, the lampholder 100 is rotated in a counter-clockwise direction when being mounted to the ceiling.

Due to the two sets of keyholes 112, 114 as shown in FIG. 1, there are two possible mounting patterns or orientations for the lampholder 100. Accordingly, there is a need to increase the number of possible mounting patterns for a lampholder without having to first unthread pre-existing threaded screws from the surface, such as the ceiling, and rethread these screws in different locations.

### SUMMARY

Objects and advantages of the present disclosure will be set forth in the following description, or may be obvious from the description, or may be learned through practice of the present disclosure.

Additional objects and advantages of the present disclosure are set forth in, or will be apparent to those skilled in the art from the detailed description herein. Also, it should be further appreciated that modifications and variations to the specifically illustrated, referenced, and discussed steps, or features hereof, may be practiced in various uses and embodiments of the present disclosure without departing from the spirit and scope thereof, by virtue of the present reference thereto. Such variations may include, but are not limited to, substitution of equivalent referenced or discussed steps, and the functional, operational, or positional reversal of various features, steps, parts, or the like. Still further, it is to be understood that different embodiments, as well as different presently preferred embodiments, of the present disclosure may include various combinations or configurations of presently disclosed features or elements, or their equivalents (including combinations of features or parts or configurations thereof not expressly shown in the figures or stated in the detailed description).

The exemplary embodiments of the present disclosure relate to surface mounting structures, and more particularly, to an electrical device, such as a compact fluorescent lampholder with occupancy sensor, having surface mounting structure for mounting the electrical device to a ceiling or other surface in a plurality of mounting patterns or orientations.

In one embodiment of the present disclosure, a lampholder with occupancy sensor is described. The lampholder includes an occupancy sensor which defines a coverage area and an un-coverage area when the lampholder is mounted to a surface, such as a ceiling and outlet box. The un-coverage area is an area which is blocked by a lamp guard positioned over a lamp of the lampholder. The lampholder includes surface mounting structure for mounting the lampholder to the ceiling. The surface mounting structure includes four sets of keyholes enabling the lampholder to be mounted to fasteners, such as, pre-threaded screws, on the ceiling in one of four different mounting patterns for positioning the un-coverage area in a desired location, such as, for example, opposite the closest entry point to a room.

### BRIEF DESCRIPTION OF THE DRAWINGS

The foregoing and other objects, features, and advantages of the present disclosure will be apparent from the following more particular description of preferred embodiments as illustrated in the accompanying drawings, in which reference characters refer to the same parts throughout the various views. The drawings are not necessarily to scale, emphasis instead being placed upon illustrating principles of the present disclosure.

FIG. 1 is a prior art lampholder having two sets of keyholes as its surface mounting structure for mounting the lampholder to a surface, such as a ceiling;

FIG. 2 is a top, perspective view of a lampholder with occupancy sensor and lamp guard in accordance with the present disclosure;

FIG. 3 is top, perspective view of the lampholder as shown in FIG. 2 with the lamp guard removed;

FIG. 4 is a bottom, perspective view of the lampholder of FIG. 2 showing four sets of keyholes as its surface mounting structure for mounting the lampholder to a surface in accordance with the present disclosure;

FIG. 5. is a bottom view of the lampholder of FIG. 2 in accordance with the present disclosure; and

FIG. 6 illustrates four different mounting patterns or orientations for the lampholder in accordance with the present disclosure.

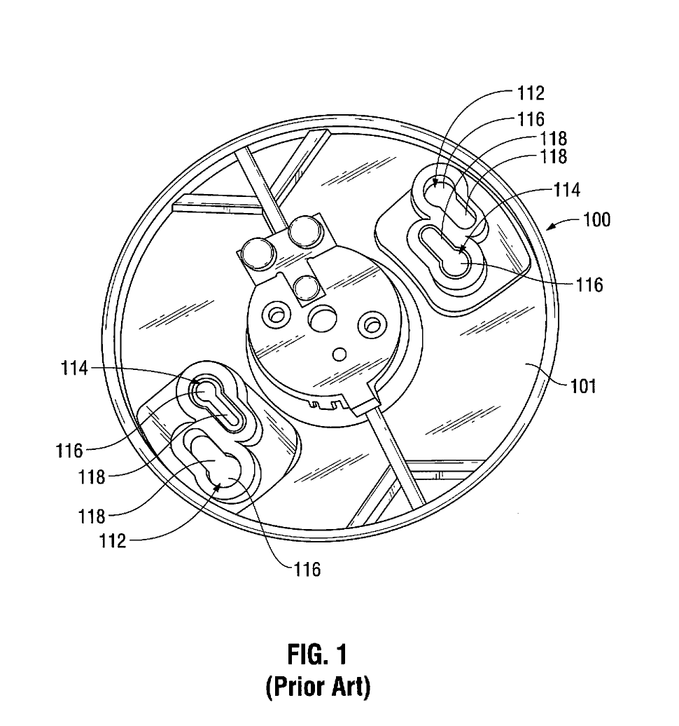

While the above-identified drawing figures set forth at least one embodiment, other embodiments of the present disclosure are also contemplated, as noted in the discussion. In all cases, this disclosure presents illustrated embodiments by way of representation and not limitation. Numerous other modifications and embodiments may be devised by those skilled in the art which fall within the scope and spirit of the principles of the present disclosure.

### DETAILED DESCRIPTION

The present disclosure proposes an electrical device having mounting structure for mounting the electrical device to a surface, such as a ceiling. In one embodiment described herein, the electrical device is a lampholder having a lamp and an occupancy sensor. The occupancy sensor provides means for hands-free lighting control. The lamp is turned on automatically when the sensor detects motion, and is turned off automatically when there is no motion. The lampholder includes surface mounting structure for mounting the lampholder to a ceiling or other surface in a plurality of mounting patterns or orientations.

More particularly, in one embodiment of the present disclosure, a lampholder with occupancy sensor is described. The lampholder can be, for example, a fluorescent lampholder, such as a compact fluorescent lampholder. The lampholder includes an occupancy sensor which defines a coverage area and an un-coverage area when the lampholder is mounted to a surface, such as a ceiling and outlet box. The un-coverage area is an area which is blocked by a lamp guard positioned over a lamp of the lampholder. The coverage area corresponds to a detection field of the occupancy sensor.

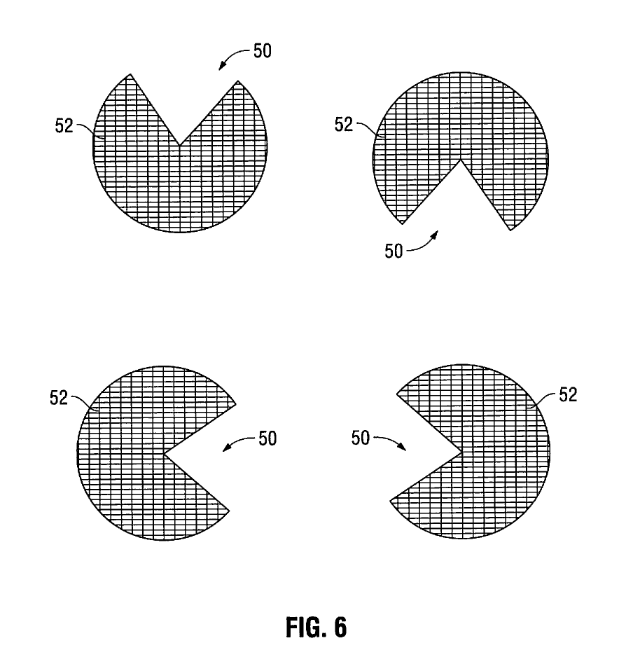

The lampholder includes surface mounting structure for mounting the lampholder to the ceiling. The surface mounting structure includes four sets of keyholes enabling the lampholder to be mounted to pre-threaded screws on the ceiling in one of four different mounting patterns or orientations (see FIG. 6) for positioning the un-coverage area in a desired location, such as, for example, opposite the closest entry point to a room.

Embodiments will be described below while referencing the accompanying figures. The accompanying figures are merely examples and are not intended to limit the scope of the present disclosure. In the description which follows, like parts are marked throughout the specification and drawings with the same reference numerals, respectively.

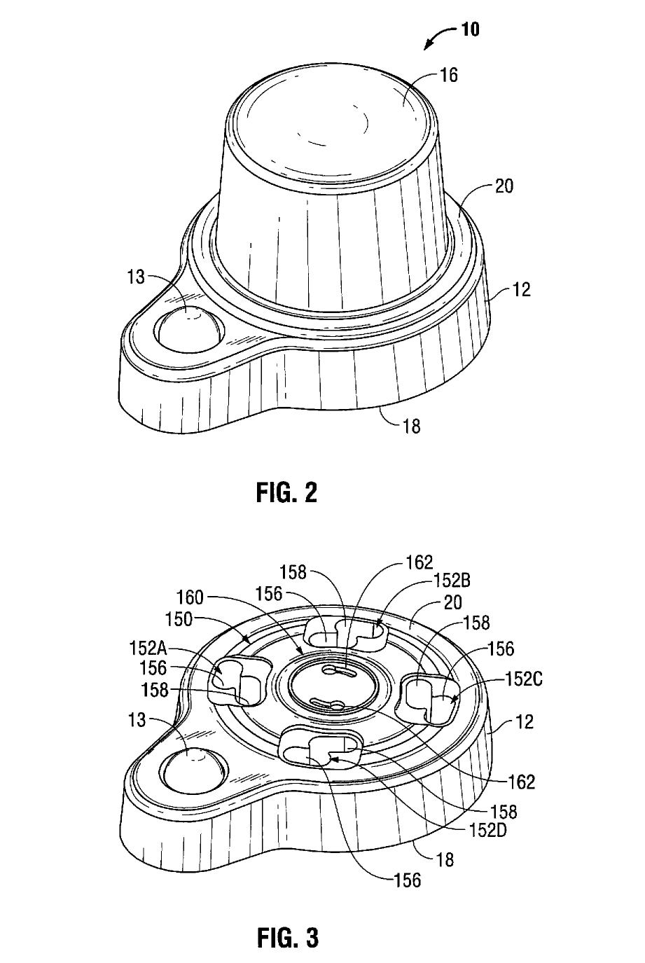

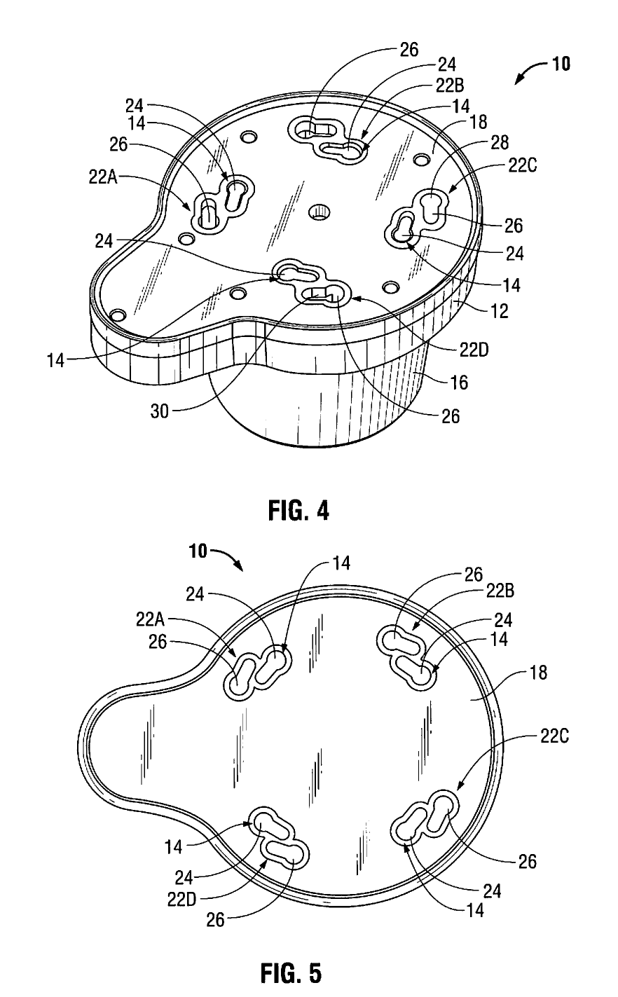

With reference to FIGS. 2 and 4, there are shown top and bottom perspective views, respectively, of a lampholder designated generally by reference numeral 10. The lampholder 10 includes a base 12, an occupancy sensor 13, a lamp guard 16, and surface mounting structure 14 on the bottom side/surface 18 of the base 12. The base 12 also includes lamp mounting structure 160 (see FIG. 3) on a top side/surface 20 for inserting therein and mounting to the lampholder 10 a lamp, such as a fluorescent lamp. The base 12 further includes lamp guard mounting structure 150 (see FIG. 3) on the top side 20 for removably mounting the lamp guard 16 to the base 12. Reference is made to related U.S. Design patent application Ser. No. 29/356,858 filed on Mar. 3, 2010 titled “Lampholder With Occupancy Sensor”; the entire contents thereof are incorporated herein by reference.

The lamp mounting structure 160 can be a socket, such as an Edison-type socket, compact fluorescent lamp (CFL) socket, lamp pin-type socket having openings 162 (as shown by FIG. 3) for receiving pins of a lamp/light bulb, or any other type of socket configured for accepting a lamp/light bulb. Also shown by FIG. 3, are four sets of through-holes or openings 152A-152D corresponding to the four set of keyholes or openings 22A-22D on the bottom side 18 of the lampholder 10. Each set of through-holes 152A-152D has two through-holes 156, 158.

Lampholder 10 further includes therein electrical circuitry (not shown) associated with the occupancy sensor 13 and the lamp mounting structure 160 for performing the various functions of the lampholder, such as sensing the presence of a person by the occupancy sensor 13 and turning on and off the lamp mounted to the lamp mounting structure 160. One skilled in the art can appreciate various designs for the electrical circuitry in order for the lampholder 10 to perform the above-noted intended functions and other functions.

The occupancy sensor 13 defines a coverage area and an un-coverage area when the lampholder 10 is mounted to a surface, such as a ceiling. The un-coverage area is an area which is blocked by the lamp guard 16 positioned over a lamp of the lampholder. The coverage area corresponds to a detection field of the occupancy sensor 13. Motion in the detection field is detected by the occupancy sensor 13. In FIG. 5, the un-coverage area is designated by reference numeral 50 and the coverage area by reference numeral 52.

With reference to FIGS. 4 and 5, the surface mounting structure 14 on the bottom side 18 of the base 12 includes four sets of keyholes or openings 22A-22D with each set having two keyholes 24, 26. That is, each set having a pair of keyholes 24, 26. The keyholes 24, 26 enable the lampholder to be mounted to fasteners, such as, pre-threaded screws, on the ceiling in one of four different mounting patterns (see FIG. 6) for positioning the un-coverage area 50 and the coverage area 52 in respective desired locations, such as, for example, positioning the un-coverage area 50 opposite the closest entry point to a room.

The four sets of keyholes 22A-22D are located on different centers to accept mounting screws for mounting the disc-shaped base 12 to a surface, such as a ceiling and outlet box. For example, keyholes 24 are for mounting the lampholder 10 to screws spaced three and one-half inches apart on the ceiling, and keyholes 26 are for mounting the lampholder 10 to screws spaced four inches apart on the ceiling. The screws are partially threaded to the surface, such as the ceiling, such that the heads are easily inserted within one of the keyholes 24, 26.

To attach the lampholder 10 to the surface, the large end apertures 28 of keyholes 26 are placed over the screw heads of two screws spaced four inches apart, and the base 12 is then rotated clockwise to position the threaded bodies of the screws into elongated slots 30. The screws are then further threaded into the ceiling or tightened to complete the assembly of the lampholder 10 to the ceiling. For screws which are spaced three and one-half inches apart, the procedure for mounting the base 12 is similar, except the orientation of the keyholes 24 are reversed and, therefore, the lampholder 100 is rotated in a counter-clockwise direction when being mounted to the ceiling.

The four sets of keyholes 22A-22D enable users to rotate the lampholder 10 360 degrees and to point the occupancy sensor 13 to the closest entry. The occupancy sensor 13 detects motion for at least one point of entry.

Even though the lampholder 10 and embodiments thereof are described herein for mounting to a surface, such as a ceiling, it is understood that the lampholder 10 is capable of mounting to a four-inch standard octagon electrical box and can include knockouts for mounting to a three and a half-inch standard octagon electrical box.

It will be appreciated that variations of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art.

1. A lampholder comprising:
a base having a lamp socket;
a sensor mounted on the base; and
surface mounting structure provided on the base for mounting the electrical device to a surface, wherein the surface mounting structure includes at least two sets of openings with each set having at least two openings.

2. The lampholder according to claim 1, wherein the at least two sets of openings each include at least one keyhole, and wherein each keyhole has a large end aperture and an elongated slot.

3. The lampholder according to claim 1, wherein the surface mounting structure is arranged and configured to enable the lampholder to be mounted to the surface in one of at least four different mounting patterns.

4. The lampholder according to claim 1, further comprising a lamp guard configured for being removably mounted to the base.

5. The lampholder according to claim 1, wherein the sensor is an occupancy sensor having a detection field, and wherein the lamp socket is disposed at least partially outside the detection field.

6. A lampholder comprising:
a base having a lamp socket;
a sensor provided on a first side of the base;
a lamp guard configured for being removably mounted to the first side of the base; and
surface mounting structure provided on a second side of the base for mounting the lampholder to a surface, wherein the surface mounting structure includes at least two sets of openings with each set having at least two opening.

7. The lampholder according to claim 6, wherein the at least two sets of openings each include at least one keyhole, and wherein each keyhole has a large end aperture and an elongated slot.

8. The lampholder according to claim 6, wherein the surface mounting structure enables the lampholder to be mounted to the surface in one of at least four different mounting patterns.

9. The lampholder according to claim 6, wherein the sensor is an occupancy sensor configured to define a coverage area and an un-coverage area when the lampholder is mounted to the surface, and wherein the lamp guard is at least partially is disposed outside the coverage area.

10. A method for mounting device lampholder to a surface, said method comprising the steps of:
providing lampholder comprising:
a base comprising a lamp socket, a sensor and mounting structure, the mounting structure being disposed on a first side of the base and being arranged and configured to mount the electrical device to a surface, wherein the mounting structure comprises at least two sets of openings each set having at least two openings, wherein the sensor is disposed on a second side of the base;
aligning at least one of the two sets of openings to a plurality of fastening locations in the surface; and
securing the electrical device to the surface by at least partially installing a plurality of fasteners in the fastening locations.

11. The method according to claim 10, wherein the at least one of the two sets of openings includes at least one keyhole, and wherein the keyhole has a large end aperture and an elongated slot, and further comprising the steps of:
rotating the electrical device to place at least one of the plurality of fastener within the elongated slot of the at least one keyhole.

12. The method according to claim 10, further comprising the step of selecting a mounting orientation for the lampholder from one of four different mounting orientations prior to the aligning step.
